(19) United States
(12) Patent Application Publication
(10) Pub. No.: US 2006/0005452 A1
(43) Pub. Date: Jan. 12, 2006

(54) Night fishing net

(76) Inventor: John McIntyre, Omaha, NE (US)

Correspondence Address: Patent, Copyright & Trademark Law Group, LLC, 202 Delaware Building, 137 South Main Street, Akron, OH, 44308, US

(21) Appl. No.: 11/177,696

(22) Filed: Jul. 8, 2005

Related U.S. Application Data
(60) Provisional application No. 60/586,451, filed on Jul. 9, 2004.

(51) Int. Cl. A01K 77/00

(52) U.S. Cl. 43/11; 43/17.5

(57) ABSTRACT

A lighted fishing net is provided which uses a clear hollow frame around the perimeter of the net. A light source, such as an incandescent lamp, mounted internally to the frame, then illuminates the frame from within. A second light source, similar to a flashlight bulb in a reflector, is positioned at the top of the handle at the frame end to shine into the net area. The handle of the invention is made of hollow plastic to allow the invention to float as well as to contain the batteries. A three-way switches has three separate control positions: one to activate the frame light; one to activate the handle light; and one to turn them both off. It is also envisioned that the handle would fold in half to save storage space.

### RELATED APPLICATIONS

The present invention claims the benefit of U.S. Provisional Patent No. 60/586,451, filed on Jul. 9, 2004, and incorporated by reference as if fully rewritten herein.

### BACKGROUND OF THE INVENTION

1. Field of the Invention

The present invention relates generally to a fishing net and, more particularly, to a fishing net with integral light sources to aid in the netting of fish while fishing at night

2. Description of the Related Art

As anyone who has ever fished at night or early in the morning before dawn will attest, the lack of light makes many ordinary tasks difficult. Perhaps the most important, and difficult, of these tasks occurs when trying to net the fish that has been caught. This task is not normally a difficult one, but the inability to see where the net is in relation to the fish makes it almost impossible in the dark. Many times the fisherman will actually knock the fish away or loose the fish if it is not completely within the net before lifting it from the water. While this problem is certainly an inconvenience for all fishermen, for those who are involved in contest fishing, it can mean the difference between winning and going home empty handed.

A search of the prior art did not disclose any patents that read directly on the claims of the instant invention; however, the following references were considered related.

U.S. Pat. No. 5,913,671, disclosing a fishing implements with illuminated handle.

U.S. Pat. No. 5,819,464, disclosing a condition-adaptable colored fishing net.

U.S. Pat. No. 5,647,160, disclosing a netting colored to induce fish to swim into net.

U.S. Pat. No. 4,501,084, disclosing a fishing net.

U.S. Pat. No. 5,647,160, disclosing a netting colored to induce fish to swim into net.

U.S. Pat. No. 6,444,247, disclosing an optical fiber display.

U.S. Pat. No. 4,800,667, disclosing an illuminated fishing net.

And, U.S. Pat. No. 2,817,175, disclosing a landing net.

Consequently, there is a need for a means by which one can easily see the outline of the fishing net and be afforded better illumination while fishing at night or during other times of low-light conditions. The development of the Night Fishing Net fulfills this need.

### SUMMARY OF THE INVENTION

It is therefore an object of the present invention to provide an improved fishing net.

It is a feature of the present invention to provide an improved fishing net with integral light sources to aid in the netting of fish while fishing at night.

Briefly described according to one embodiment of the present invention, the invention uses a clear hollow frame around the perimeter of the net. A light source, such as an incandescent lamp, mounted internally to the frame, then illuminates the frame from within. A second light source, similar to a flashlight bulb in a reflector, is positioned at the top of the handle at the frame end to shine into the net area. The handle of the invention is made of hollow plastic to allow the invention to float as well as to contain the batteries. A three-way switches has three separate control positions: one to activate the frame light; one to activate the handle light; and one to turn them both off. It is also envisioned that the handle would fold in half to save storage space.

The use of the Night Fishing Net provides a distinct advantage when netting fish at night or under low-light conditions in a manner, which is quick, easy and effective.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a perspective view of the preferred embodiment of a night fishing net according to the present invention; and

FIG. 2 is a perspective view of a handle used therewith.

### DESCRIPTION OF THE PREFERRED EMBODIMENTS

The best mode for carrying out the invention is presented in terms of its preferred embodiment, herein depicted within the Figures.

### 1. Detailed Description of the Figures

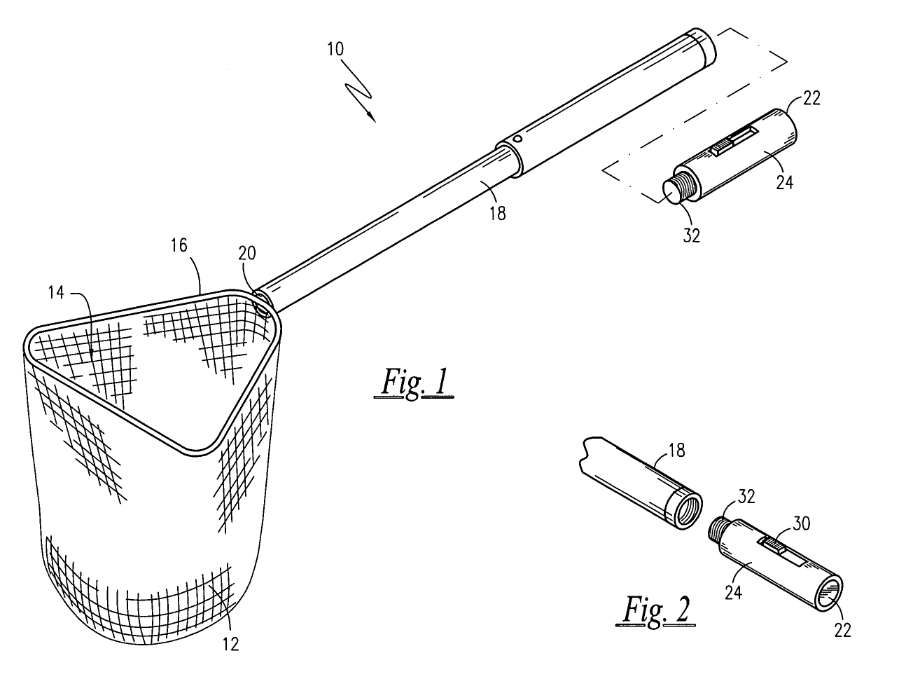

Referring now to the FIG. 1, a fishing net, generally referred to by reference numeral 10, is shown having a net 12 supported around a circumscribed opening 14 by a clear hollow frame 16 around the perimeter of the net. An elongated handle 18 extends laterally outward from the frame 16, and a light source 20, such as an incandescent lamp, mounted internally within the handle 18 and is directed to the frame 16, thereby illuminating the frame 16 from within. A second light source 22, similar to a flashlight bulb in a reflector, is positioned at the a hand grip 24 located at the top of a handle 18.

Referring to FIG. 2, the handle section 6 is shown in greater detail affixed to the lower end of the shaft 4. The hand grip 24 of the invention is made of hollow plastic to allow the invention to float as well as to contain the batteries. A three way switch 30 has three control positions: one to activate the frame light; one to activate the handle light; and, one to turn them both off. It is also envisioned that the hand grip 24 would detach, and the handle 18 be telescoping or collapsible in order to save storage space. The hand grip 24 holds and contains a battery assembly, as does the upper end of the handle assembly 18. A plurality of batteries stored within a cavity inside the handle section power the light sources. A series of threads 32 are formed along the lower rim of the handle, with matching, receiving threads mate to the threads such as to removably contain the batteries.

Although the batteries can be of the disposable type, it is also envisioned that the batteries can be supplied as a rechargeable type battery that is typical of modern rechargeable tools and devices being an elongated cylinder with a positive pole on one end and a negative pole on the other. Such batteries are typically charged on a battery charger that sits on a counter type and is plugged into conventional household power outlets. A rechargeable battery can then be removed from handle and then be recharged with a conventional counter-top battery charger.

### 2. Operation of the Preferred Embodiment

In operation, and in reference to both FIG. 1 and FIG. 2, the present invention is utilized merely as a normal fishing net. The use of the Night Fishing Net provides a distinct advantage when netting fish at night or under low-light conditions in a manner, which is quick, easy and effective. Upon entering a dark location, the user activates the illumination source by use of a switch.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents. Therefore, the scope of the invention is to be limited only by the following claims.

Having thus described the invention what is claimed as new and desired to be secured by Letters Patent is as follows:

1. A fishing net with integral light sources to aid in the netting of fish while fishing at night.

2. An illuminated fishing implement comprising:
a telescopic, illuminated handle adapted to illuminate a meshed net attached thereto.

3. The illuminated fishing implement of claim 2, wherein said meshed net is fabricated of a buoyant material disposed on a hollow, illuminated net frame which is suitably attached to an illuminating end of the handle in a manner so as to allow the net to be illuminated by handle.

4. A fishing net comprising:
a net supported around a circumscribed opening by a clear hollow frame around the perimeter of the net;
an elongated handle extending laterally outward from said frame; and
a light source mounted internally within said handle; whereby said light source is directed to said frame, thereby illuminating said frame from within.

5. The fishing net of claim 4, further comprising a second light positioned at the a hand grip located at a lower end of said handle.

6. The fishing net of claim 5, wherein said hand grip is made of hollow plastic to allow it to float as well as to contain batteries for powering said light source.

7. The fishing net of claim 6, further comprising a three way switch having three control positions: one to activate the frame light; one to activate the handle light; and, one to turn them both off.

8. The fishing net of claim 5, wherein:
said hand grip is detachable; and
said handle is collapsible in order to save storage space.
